(19) United States
(12) Patent Application Publication
(10) Pub. No.: US 2018/0178526 A1
(43) Pub. Date: Jun. 28, 2018

(54) METHOD AND DEVICE FOR CLEANING PRINT HEADS IN AT LEAST ONE PRINT HEAD BAR

(71) Applicant: Océ Holding B.V., Venlo (NL)

(72) Inventors: Admir Lela, Haar (DE); Kay Luecke, Fuerstenfeldbruck (DE); Oliver Eck, Finsing (DE)

(73) Assignee: Océ Holding B.V., Venlo (NL)

(21) Appl. No.: 15/851,015

(22) Filed: Dec. 21, 2017

(30) Foreign Application Priority Data
Dec. 22, 2016 (DE) 10 2016 125 321.9

(51) Int. Cl. B41J 2/165

(52) U.S. Cl. CPC B41J 2/16552; B41J 2002/16594; B41J 2/16535; B41J 2/16585

(57) ABSTRACT

In a method for cleaning print heads that are arranged in at least one row within at least one print bar, a position of a spray nozzle can be determined, and a nozzle surface can be sprayed using the spray nozzle. The nozzle surface can be sprayed with at least one liquid cleaning jet, and can be based on the determined position of the spray nozzle. The at least one liquid cleaning jet can strike the nozzle surface at an obtuse angle of incidence. The spraying of the at least one liquid cleaning jet can be omitted if the spray nozzle is located in a gap between two adjacent print heads.

### CROSS REFERENCE TO RELATED APPLICATIONS

This patent application claims priority to German Patent Application No. 102016125321.9, filed Dec. 22, 2016, which is incorporated herein by reference in its entirety.

### BACKGROUND

The present disclosure relates to a method and device to clean print heads in at least one print head bar.

EP 2 418 087 A1 describes a cleaner for the cleaning of a print head for an inkjet printing apparatus that has a wiping lip which may be moved along the print head. The wiping lip is arranged stationary and the print head is moved along the wiping lip. The cleaner is provided with a cleaning unit to clean the wiping lip itself. For this, the wiping lip is sprayed with a cleaning agent and subsequently dried with compressed air.

U.S. Pat. No. 7,510,265 B2 describes an inkjet printing apparatus that has a cleaner for cleaning the print head. The cleaner is designed so as to be movable along the print head. The cleaner has a vapor hood that is open at the top, in which are provided a wiping lip and a nozzle to dispense a heated cleaning agent. The print head is sprayed with a hot vapor that is supplied under pressure when the vapor hood is moved along the print head. The print head is simultaneously scraped by the wiping lip. The hot vapor condenses on the surface of the print head and the condensed fluid is removed again by the wiping lip.

Printing apparatuses can have a cleaner for the cleaning of the print head, with which the print head may be automatically wiped off with a wiping device. For this, the surface of the print head is wetted with additional ink so that, upon wiping off the print head, residues of previous printing processes that are present and have possibly dried on the print head are loosened and carried along by the liquid ink.

In order to increase the print quality of inkjet printing apparatuses, a quick drying ink is increasingly being used. Although a quick drying ink dries very quickly on a recording medium, it also has the disadvantage that residues on the print head, in particular in the area of the print nozzles, also dry up more quickly and negatively affect the further printing process.

The print heads are often provided with a coating that increases the surface tension in order to reduce the wettability of the nozzle surface. This coating is sensitive and limits the force with which a wiping lip may be pressed against the surface in order to wipe this off.

Given use of a conventional ink, the print heads are typically stripped with a wiping lip every two hours. Given use of a quick drying ink, contamination problems may occur even if these intervals between the individual cleaning processes are significantly shortened. A shortening of the intervals additionally leads to a significantly greater downtime of the printing apparatus, and therefore to a significantly reduced productivity.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a cleaner for a print head according to an exemplary embodiment of the present disclosure.

FIG. 2 illustrates a perspective view of a sled with spray nozzles and wiping lips, together with a linear drive, a basin and a cleaner, according to an exemplary embodiment of the present disclosure.

FIGS. 3-7 respectively illustrate a front view of a print bar and the cleaner in successive operating states according to exemplary embodiments of the present disclosure.

FIG. 8 illustrates a bottom view of a print bar with multiple print heads without linear guide according to an exemplary embodiment of the present disclosure.

FIG. 9 illustrates a spray nozzle together with a spray cone that can be generated with the spray nozzle according to an exemplary embodiment of the present disclosure.

FIG. 10 illustrates the angle of incidence α according to an exemplary embodiment of the present disclosure.

FIG. 11 illustrates a bottom view of a print bar with multiple print heads having two linear guides according to an exemplary embodiment of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

Inkjet printers can be used in digital high-capacity printing. What is understood as high-capacity printing is the use of a printer that can print to at least 10 pages of DIN A4 size per second. However, printers for high-capacity printing may also be designed for higher print speeds, for example at least 30 pages of DIN A4 per second, and in particular at least 50 DIN A4 pages per second.

Inkjet printers for digital high-capacity printing can include a stationary print bar having multiple print heads respectively having a plurality of print nozzles. Such a print head may have a few hundred to a few thousand print nozzles. A separate actuator is associated with each print nozzle. This actuator acts like a small pump upon whose activation a pressure pulse is exerted on the ink located in the supply line of the print nozzle, such that a droplet of ink is ejected from the respective print nozzle.

The present disclosure relates to a method and a device for cleaning a print head having a plurality of print nozzles. According to aspects of the disclosure, a print head may be cleaned in a simple manner of residues of quick drying ink and without a surface coating of the print head being damaged.

In an exemplary embodiment, the print heads are arranged in at least one row. The nozzle surface of the print head can be sprayed with at least one liquid cleaning jet that strikes the nozzle surface at an obtuse angle of incidence. The nozzle surface may subsequently be wetted with ink. The nozzle surface may then also be wiped off with a wiping lip.

In an exemplary embodiment, by spraying the nozzle surface of the print head with a “slanted” cleaning jet, the cleaning fluid may prevented from (or the occurrence reduced) penetrating into the nozzle opening, which may negatively affect the composition (e.g. viscosity) of the ink in the nozzle opening (or nozzle itself) there. The slanted cleaning jet can dissolve residues of ink that are located on the nozzle surface. Moreover, by the wetting of the nozzle surface with ink, the ink output at the print nozzles mixes with the cleaning fluid. The ink contains a “carrier fluid” which dissolves and dilutes the particles of the ink well. The mixture of ink and cleaning fluid thus dissolves the residues that are already softened by the cleaning fluid, such that these may be wiped off with the wiping lip without high pressure. Furthermore, via the wetting of the nozzle surface with ink, it is ensured that the individual print nozzles are completely filled with ink. This prevents (or reduces the likelihood) the fluid on the nozzle surfaces containing dissolved ink residues from being pushed into the print nozzles, which could possibly contaminate or even clog the nozzles upon stripping or wiping off the nozzle surface with the wiping lip. In this example, the fluid can include the cleaning fluid and the printing ink.

In an exemplary embodiment, the angle of incidence between cleaning jet and nozzle surface is between 30° and 50°. In an exemplary embodiment, the angle of incidence is 45°. The angle of incidence is not limited, and can be other angular values as would be understood by one of o

In an exemplary embodiment, the combination of spraying of the nozzle surface of the print head with a cleaning fluid and the wetting of the nozzle surface with ink via the supply of ink by the print nozzles advantageously produces a very efficient cleaning that is effective, and even so when using quick drying ink.

In an exemplary embodiment, a quick drying ink, such as a latex-based ink, can be used.

The spraying of the nozzle surface of the print head with a cleaning fluid is significantly simpler to execute than the climate control of the inkjet printer or of the printing area of the inkjet printer. This method may be executed in any typical production environment.

In an exemplary embodiment, the cleaning fluid can act at a predetermined time period, for example, 3 to 120 seconds after the spraying of the nozzle surface, but is not limited thereto.

In an exemplary embodiment, it may be appropriate that, after the cleaning process, the nozzle surface is sprayed with cleaning fluid again. It is hereby ensured that ink located in the region of nozzle openings does not dry up until the printing process is resumed and additional ink is conveyed via the print nozzles.

In an exemplary embodiment, water or a solution having surfactants, in particular an aqueous solution, may be used as a cleaning fluid, but is not limited thereto. In an exemplary embodiment, an aqueous solution having surfactants is used since this very efficiently dissolves ink residues and additionally provides moisture that prevents a further drying out of ink at the nozzle surface.

In an exemplary embodiment, the wiping lip may be dried after the wiping. In this example, compressed air may be blown on the wiping lip so that ink residues from the preceding wiping processes are not applied onto the nozzle surface by the wiping lip at the next wiping process.

In an exemplary embodiment, in the spraying of the nozzle surface, the cleaning fluid is sprayed from a spray nozzle at the nozzle opening with a delivery pressure of not more than 0.9 bar. In an exemplary embodiment, the delivery pressure is not more than 0.5 bar. It is hereby ensured that the cleaning fluid does not penetrate into the nozzles. The pressure is not limited hereto and can be other pressure values as would be understood by one of ordinary skill in the relevant arts.

The method for cleaning print heads can be used in digital high-capacity printing. Printers for digital high-capacity printing can include print bars which have multiple print heads that are arranged offset from one another. The spraying of the print heads can then be executed in multiple sections so that essentially only the nozzle surfaces are sprayed, and not the regions of the print bar that are located between the nozzle surfaces.

In an exemplary embodiment, a cleaning device to clean print heads (the print heads being arranged in at least one row) in at least one print head bar includes at least one spray nozzle to generate a cleaning jet. The liquid cleaning jet can be configured to strike the nozzle surface at an obtuse angle of incidence upon cleaning. The device may have a wiper with at least one wiping lip to wipe off the nozzle surface. The spray nozzle and the wiping lip can be arranged on a common sled which can be moved along the nozzle surface.

In an exemplary embodiment, the cleaning device can include a positioner that is configured to adjust the spacing between the sled and the nozzle surface. The spacing can be adjusted between a wiping position and a spraying position. In a wiping position, the wiping lip rests on the nozzle surface. In a spraying position, the wiping lip is spaced from the nozzle surface. The sled can be configured to be moveable along the nozzle surface for wiping off the nozzle surface in the wiping position and for spraying the nozzle surface in the spraying position.

In that the sled and the nozzle surface may be arranged at different distances from one another, the sled may be moved once to strip the nozzle surface (e.g. wipe the surface) with the wiping lip and, independently of this, may be moved to spray the nozzle surface with cleaning agent via the spray nozzle. The spraying and the wiping are thus decoupled from one another, and the time the cleaning fluid remains on the nozzle surface may be arbitrarily set. The distance of the spray nozzle from the nozzle surface may thereby be greater than the distance of the wiping lip from the nozzle surface during the usage of the corresponding element.

In an exemplary embodiment, at least one linear guide is provided for the movement of the sled. A basin open at the top may be arranged along the linear guide. The sled may extend across the region, above the basin, so that the wiping lip and the spray nozzle are located in the region above the basin. A waste solution (e.g. the dissolved ink residues wiped from the nozzle surface) that is stripped/wiped with the wiping lip may hereby be captured in the basin.

In an exemplary embodiment, the sled may include two spray nozzles that are arranged offset transversal to the direction of movement. The nozzle surfaces of print heads that are offset in a row in a print bar may respectively be cleaned with each of the two spray nozzles.

In an exemplary embodiment, the sleds may also have two wiping lips which are respectively associated with one of the two spray nozzles.

In an exemplary embodiment, the spray nozzle is configured to spray cleaning fluid in a predefined spray cone. The spray nozzle may, alternatively or in combination, spray a flat jet or a fan jet situated in one plane. The spacing of the spray nozzle from the nozzle surface may be variably adjusted.

The wiping lip can be appropriately arranged outside of the spray cone so that it is not wetted upon spraying the nozzle surface with cleaning fluid.

The spray cone can be, for example, a hollow cone (i.e. most droplets of spray fluid are located within a ring area).

In an exemplary embodiment, the spray nozzle is a two-component nozzle to which cleaning fluid and air are supplied. The air serves to entrain and atomize the cleaning fluid. The cleaning fluid can be supplied at very low pressure (or practically without any pressure). In an exemplary embodiment, the spray pressure is essentially set by the pressure with which the air is supplied. The individual droplets of cleaning fluid are optimally small and finely atomized in order to achieve an optimally uniform wetting of the nozzle surface.

In an exemplary embodiment, the cleaner can include a dryer that is configured to clean and dry the wiping lip. In an exemplary embodiment, the dryer includes an air nozzle with which the wiping lip may be cleaned and dried by an air current. In principle, it is also possible that the dryer is provided with an additional spray nozzle with which the wiping lip may be sprayed with the cleaning fluid.

In an exemplary embodiment, the cleaner includes a controller that is configured to execute one or more method/processes of the exemplary embodiments of the present disclosure. The controller can include processor circuitry that is configured to perform one or more operations and/or functions of the controller.

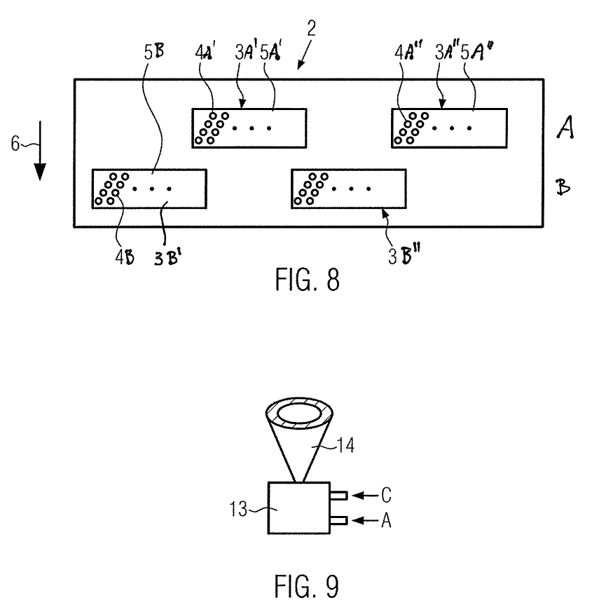

FIG. 1 illustrates a cleaner 1 according to an exemplary embodiment that is configured to clean a print bar 2. The print bar 2 includes multiple print heads 3A and 3B as shown in FIG. 8. Each print head 3A and 3B has a plurality of print nozzles 4A and 4B. The print nozzles 4 are configured in a predetermined pattern at the print heads 3. Different arrangements of the print nozzles 4A and 4B at the print heads 3A and 3B can be used. In an exemplary embodiment, the print heads 3A and 3B respectively have a rectangular nozzle surface 5A′ at which the print nozzles 4 open. In other aspects, the print heads 3 can include a trapezoidal nozzle surface.

In an exemplary embodiment, two rows of print heads 3 extend in the longitudinal direction of the print bar 2 and are arranged at the print bar 2: an upper row A in FIG. 8 and a lower row B in FIG. 8. The upper print heads 3A′ and 3A″ are arranged in the upper row A traveling horizontally. In contrast, the print heads 3B′ and 3B″ depicted below in FIG. 8 are arranged in the lower row B traveling horizontally. In a printing process, a recording medium is conveyed in the conveyance direction 6, which runs transversal to the longitudinal direction of the print bar 2 (FIG. 8). The print heads 3A′ and 3A″ of the upper row A are respectively arranged so that the gaps between two adjacent print heads 3B′ and 3B″ in the lower row of print heads are covered by a print head of the adjacent row so that, on a recording medium that is conveyed in the conveyance direction 6 along the print bar 2. Ink may be applied without gaps in the region between the longitudinal direction of the print bar 2 running transversal to the conveyance direction 6.

In an inkjet printer, a print bar 2 can be arranged with the nozzle surfaces 5 pointing downward. Therefore, in the following description, the directions “below” and “above” are used so that the nozzle surfaces 5, and therefore the print nozzles 4, are arranged facing downward. However, it is also possible in principle to align a print bar in a different direction in the printer, even if this is not typical.

The print bar 2 is held at its ends by a positioner 7, which is configured to raise and lower the print bar 2 in the vertical direction 8 (FIG. 1). The print bar may also be provided with a movement device which may move the print bar back and forth between a position in which it is located over the cleaner 1 and a position in which it is located over a recording medium to be printed to. In an exemplary embodiment, the print bar 2 is arranged immobile in the inkjet printer. A recording medium (not shown) to be printed to is moved with a corresponding transport device along the nozzle surfaces of the print bar 2 to print to said recording medium.

In an exemplary embodiment, the cleaner 1 includes at least one linear guide 9 at which at least one sled 10 is arranged so as to be displaceable. In an exemplary embodiment, the linear guide 9 includes at least one motor 11 configured to move the sled 10 automatically along the linear guide.

Located on the sled 10 is at least one wiping lip 12 that is arranged with its wiping edge pointing vertically upward and transversal to the linear guide 9.

In an exemplary embodiment, arranged on the sled 10 is at least one spray nozzle 13 having its nozzle opening pointing upward.

In an exemplary embodiment, the spray nozzle 13 is a two-component nozzle to which are supplied a cleaning fluid (C) and air (A) (FIG. 9). The air flow in the spray nozzle 10 entrains the cleaning fluid, where the cleaning fluid C is atomized into small droplets and is sprayed at the upwardly pointing nozzle opening. In an exemplary embodiment, the spray nozzle 13 is configured to spray the cleaning fluid in the form of a spray cone 14. The spray cone 14 can be essentially hollow in the middle, where the droplets of the spray fluid are located essentially in a region of an annular disc that widens with increasing distance from the spray nozzle 13.

In an exemplary embodiment, air is supplied to the spray nozzle 13 with a pressure of, for example, 0.5 bar, but is not limited thereto. The lower the pressure with which the cleaning fluid is sprayed from the spray nozzle 13, the lower the risk that cleaning fluid may enter into the print nozzles 4 of the print bar 2 or print heads 3.

In an exemplary embodiment, the spray nozzle 13 is connected with a cleaning fluid reservoir via, for example, an elastic line.

In an exemplary embodiment, the spray nozzle 13 is arranged at the sled 10 in relation to the wiping lip 12 so that the wiping lip 12 is located outside of the spray cone 14. It is hereby ensured that, upon spraying the spray nozzle 13, the wiping lip 12 is not sprayed with cleaning fluid.

In an exemplary embodiment, the cleaner 1 includes a dryer 16 at one end of the linear guide 9. The dryer 16 can include an air nozzle 17 with which the wiping lip 12 may be charged with an air flow if the sled 10 is located at a corresponding end position at the linear guide 9.

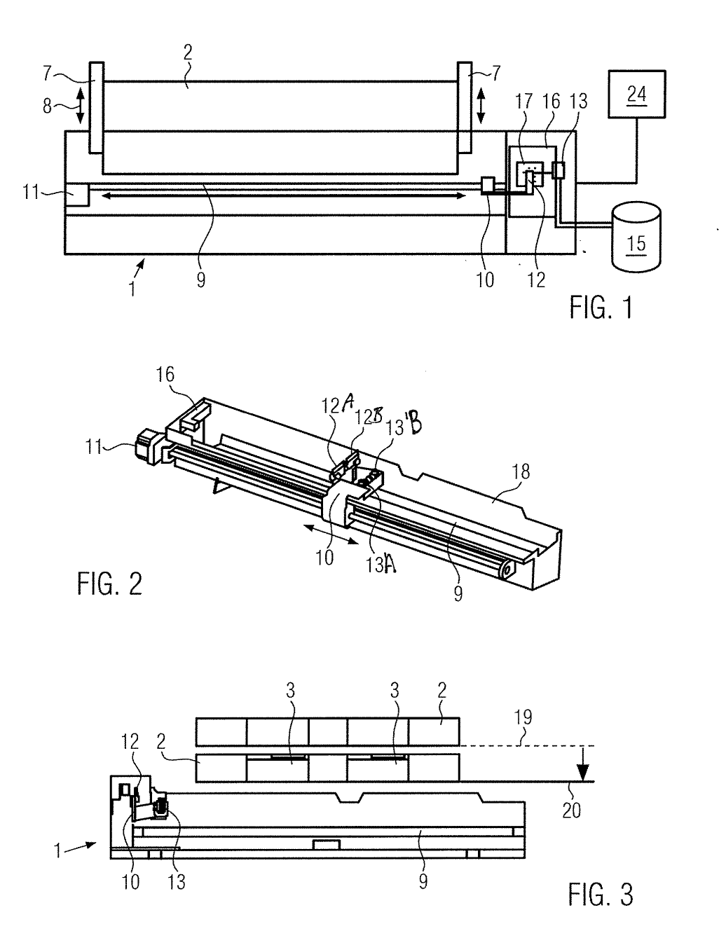

In an exemplary embodiment, the sled 10 includes two wiping lips 12A and 12B and two spray nozzles 13A and 13B (FIG. 2). The spray nozzle 13A and the corresponding wiping lip 12A are associated with the print heads 3A′ and 3A″ of the print bar 2, and the spray nozzle 13B and the corresponding wiping lip 12B are associated with the print heads 3B′ and 3B″ of the print bar 2.

In an exemplary embodiment, an elongated basin 18 is provided along the linear guide 9. The elongated basin 18 can be open at the top. The sled 10 extends in the region above the basin 18 so that the wiping lips 12 and the spray nozzles 13 are arranged above the basin 18.

In an exemplary embodiment, the wiping lips 12 are fashioned from an elastic plastic, such as a silicone plastic. Advantageously, silicone plastic is inert relative to most fluids and, in addition to this, water and aqueous solutions roll well off of a silicone plastic.

The functionality of the cleaner 1 is explained with reference to FIGS. 3-7.

First, the print bar 2 is lowered from an initial position 19 to a spray position 20 as shown in FIG. 3. In the spray position 20, the print bar 2 with the nozzle surfaces 5 is located a bit above the sled 10, with a small clearance from the wiping edges of the wiping lips 12 and the spray nozzles 13. In the spray position 20, the wiping lips 12 cannot come into contact with the nozzle surfaces 5 of the print bar 2.

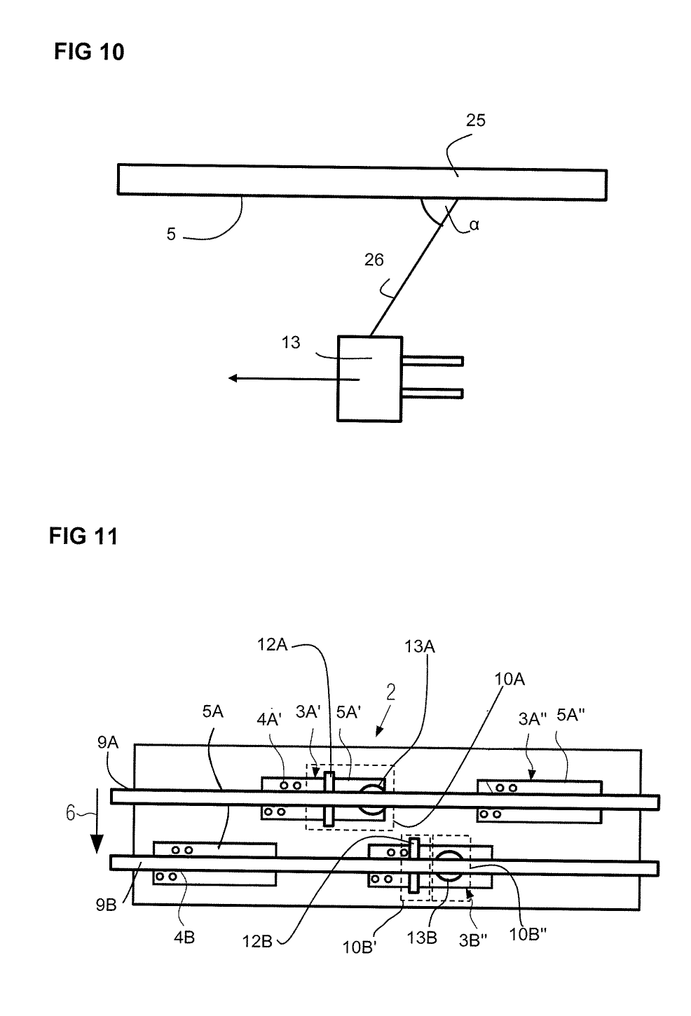

The liquid cleaning jet 26 pushed out of the spray nozzle 13 strikes the nozzle surface 5 at an angle of incidence α, as depicted in FIG. 10. Of the print bar 2, only the printing plate 25 with the nozzle surfaces 5 is depicted.

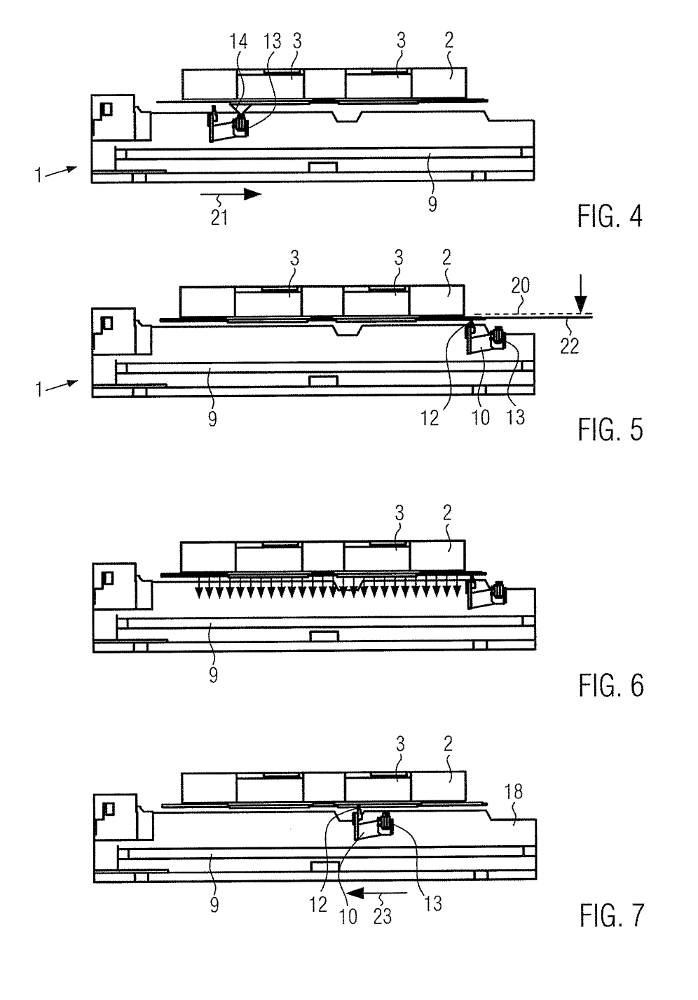

As shown in FIG. 4, in the spray position, the sled 10 is moved with a first movement direction 21 along the print bar 2, and in particular along the nozzle surfaces. The spray nozzle 13 can be configured to respectively spray cleaning fluid upward. The spray nozzle 13 is located in the region below one of the nozzle surfaces 5 of the print heads 3. In an exemplary embodiment, the spray nozzles 13 are thus only switched to be active if they are located in the region below one of the print heads 3 or its nozzle surface 5.

In an exemplary embodiment, an aqueous solution which contains surfactants is used as a cleaning fluid.

As shown in FIG. 5, if the sled 10 is located at its end position relative to the linear guide 9, then the print bar 2 is lowered one more time with the positioner 7 from the spray position 20 into the wiping position 22. In the wiping position, the nozzle surfaces 5 are arranged slightly above the upwardly facing wiping edges of the wiping lips 12 when the wiping lips 12 extend freely upward.

In an exemplary embodiment, the cleaning fluid located on the nozzle surfaces 5 may act (e.g. remain on the surface) for a predetermined duration of, for example, up to 120 seconds and dissolve ink residues on the nozzle surfaces 5. The nozzle surfaces 5 are subsequently wetted with printing ink (FIG. 6). The print nozzles 4 are provided with actuators (not shown) with which ink may be sprayed from the print nozzles 4. These actuators are operated to wet the nozzle surfaces 5 such that ink only somewhat exits from the print nozzles 4 and wets the nozzle surface 5 in the region around the print nozzles. The ink hereby mixes with the cleaning fluid. The amount of liquid located on the nozzle surfaces 5 is thereby increased. Furthermore, the print nozzles 4 are completely filled with toner fluid.

Turning to FIG. 7, the sled 10 may now be moved in a second movement direction 23 that is counter to the first movement direction, such that the wiping lips 12 scrub across the nozzle surfaces 5 of the print bar 2 and strip the present mixture of cleaning fluid and ink, together with the ink residues dissolved therein. The fluid stripped with the wiping lips 12 drops into the basin 18, which is emptied at regular intervals.

With a back-and-forth movement of the sled 10, the cleaning fluid may thus be applied, and then the cleaning fluid together with the additional ink may be stripped.

With this method, print heads 3 may be reliably cleaned even if the print heads 3 are used for printing to recording media with quick drying ink, for example latex-based ink for printing to a recording medium.

In an exemplary embodiment, a central controller 24 can be configured to automatically execute the entire cleaning process. The central controller 24 can be configured to control the motor 11 of the linear guide 9, the spray nozzles 13, and the positioner 7 (FIG. 1). In an exemplary embodiment, the central controller 24 includes processor circuitry that is configured to perform one or more functions and/or operations of the central controller 24, including controlling the linear guide 9, nozzles 13, and positioner 7.

In an exemplary embodiment, the print bar 2 is moved relative to the cleaner 1 into the different positions 19, 20, 22. Within the scope of the disclosure, it is naturally also possible to move the cleaner 1 accordingly in the vertical direction and to arrange the print bar 2 stationary.

In an exemplary embodiment, with the dissolving of the ink residues on the nozzle surfaces 5, it is possible to strip the dissolved ink residues with a reduced pressure that presses the wiping lips 12 against the nozzle surfaces 5. That is, the stripping can be performed without the wiping lips 12 having to be pressed with a high pressure against the nozzle surfaces 5. Advantageously, the cleaning method according to one or more exemplary embodiments is therefore also suitable for cleaning print heads or print bars which are coated with a sensitive coating, in particular with an anti-wetting coating or nano-coating.

After every cleaning process, a dryer 16 can be configured to dry the wiping lips 12 and clean the fluid residues of the last cleaning process off the wiping lips 12.

The cleaner 1 depicted in FIGS. 1 through 7 has only a single linear guide 9 on which the single sled 10 may be displaced in translation. In this embodiment, all wipers 12A and 12B and the spray nozzles 13A and 13B may only be displaced simultaneously with the sled 10.

A lower view of a print bar 2 as in FIG. 8 is depicted in FIG. 11. In addition, FIG. 11 shows two linear guides 9A and 9B. In an exemplary embodiment, the corresponding wiper 12A and the corresponding spray nozzle 13A share a sled 10A (shown in dashed lines). This might be realized similarly in the lower linear guide 9B for the corresponding wiper and for the corresponding spray nozzle. The two sleds 10A and 10B′ might therefore be moved independently of one another so that the rows A and B might be cleaned differently.

In an exemplary embodiment, a first sled 10B′ (shown in dashed lines) with a wiper 12B and a second sled 10B″ (likewise shown in dashed lines) with a spray nozzle 12B are arranged on the lower linear guide 9B. In this embodiment, both the wiper 12B and the spray nozzle 13B advantageously may be displaced in translation, independently of one another, within a row.

The embodiments depicted in FIG. 11 can also be combined with one another. In these embodiments, the liquid cleaning jet does not need to strike at an obtuse angle of incidence, but rather may also strike orthogonal to the nozzle surface.

With the achieved degrees of freedom, a specific print head might be specifically approached and only this might be cleaned. This would have the advantage that the anti-wetting layer of the other print heads is preserved.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, “processor circuitry” can include one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

1 cleaner
2 print bar
3 print head
4 print nozzle
5 nozzle surface
6 conveyance direction
7 positioner
8 direction
9 linear guide
10 sled
11 motor
12 wiping lip
13 spray nozzle
14 spray cone
15 cleaning fluid reservoir
16 dryer
17 air nozzle
18 basin
19 initial position
20 spray position
21 first movement direction
22 wiping position
23 second movement direction
24 central controller
25 printing plate
26 liquid jet
α angle of incidence

1. A method for cleaning print heads that are arranged in at least one row within at least one print bar, the method comprising:
determining a position of a spray nozzle; and
spraying, using the spray nozzle, a nozzle surface of one of the print heads with at least one liquid cleaning jet based on the determined position of the spray nozzle, the at least one liquid cleaning jet being configured to strike the nozzle surface at an obtuse angle of incidence, wherein the spraying of the at least one liquid cleaning jet is omitted if the spray nozzle is located in a gap between two adjacent print heads.

2. The method according to claim 1, further comprising:
wetting the nozzle surface with ink; and
wiping off the nozzle surface with a wiping lip.

3. The method according to claim 1, wherein cleaning fluid of the at least one cleaning jet is sprayed from the spray nozzle with a pressure of not more than 0.5 bar.

4. The method according to claim 1, wherein the at least one cleaning jet is shaped such that essentially only the respective nozzle surface is wetted with a cleaning fluid of the at least one cleaning jet.

5. The method according to claim 1, wherein the nozzle surface is sprayed by the at least one cleaning jet if the determined position of the spray nozzle is in a region below one of the print heads.

6. A non-transitory computer-readable storage medium with an executable program stored thereon, wherein, when executed, the program instructs a processor to perform the method of claim 1.

7. A device adapted to clean print heads arranged in a nozzle row within at least one print bar, the device comprising:
a spray nozzle configured to generate a cleaning jet adapted to strike a nozzle surface of the at least one print bar at an obtuse angle of incidence to clean the nozzle surface;
a linear guide traveling along the nozzle row;
a sled configured to be movable on the linear guide; and
a wiping lip, wherein the print nozzle and/or the wiping lip are connected with the sled.

8. The device according to claim 7, further comprising:
a second linear guide traveling along a second nozzle row;
a second sled configured to be movable on the second linear guide independent of the sled;
a second wiping lip;
a second print nozzle, wherein the second print nozzle and/or the second wiping lip are arranged in the second sled.

9. The device according to claim 7, wherein the angle of incidence is between 30° and 50°.

10. The device according to claim 7, wherein the cleaning jet is shaped like a hollow cone or a flat jet.

11. The device according to claim 7, wherein the spray nozzle is configured to generate the cleaning jet to arrive only at the nozzle surface upon cleaning.

12. A device adapted to clean print heads arranged in respective nozzle rows within at least one print bar, the device comprising:
a first spray nozzle configured to generate a first cleaning jet adapted to strike a first nozzle surface of the at least one print bar at a first obtuse angle of incidence to clean the first nozzle surface;
a second spray nozzle configured to generate a second cleaning jet adapted to strike a second nozzle surface of the at least one print bar at a second obtuse angle of incidence to clean the second nozzle surface;
a first linear guide traveling along a first nozzle row and a second linear guide traveling along a second nozzle row;
a first sled configured to be movable on the first linear guide;
a second sled configured to be movable on the second linear guide independent of the first sled; and
first and second wiping lips, wherein:
the first print nozzle and/or the first wiping lip disposed on the first sled; and
the second print nozzle and/or the second wiping lip are disposed on the second sled.

13. The device according to claim 12, wherein the first and second obtuse angles of incidence are different.

14. The device according to claim 12, wherein the first and second obtuse angles of incidence are the same different.

15. The device according to claim 12, wherein the angle of incidence is between 30° and 50°.

16. The device according to claim 12, wherein the first cleaning jet and/or the second cleaning jet is shaped like a hollow cone or a flat jet.
